(19) United States
(12) Patent Application Publication
(10) Pub. No.: US 2010/0171788 A1
(43) Pub. Date: Jul. 8, 2010

(54) INK-JET PRINTER HAVING SUCTION FUNCTION AND METHOD OF OPERATING THE SAME

(75) Inventors: Jung-dae HEO, Hwaseong-si (KR); Gu-hwan NA, Seoul (KR); Gun HEO, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/543,608

(22) Filed: Aug. 19, 2009

(30) Foreign Application Priority Data
Jan. 8, 2009 (KR) 2009-1527

(51) Int. Cl. B41J 2/165

(52) U.S. Cl. 347/30

(57) ABSTRACT

An inkjet printer having a suction function and a method of operating the inkjet printer includes a suction instrument that applies a suction force toward a platen so as to closely attach a printing medium to the platen during a printing operation and to suck spitted ink in a printing standby state.

### CROSS-REFERENCE TO RELATED APPLICATIONS

This application claims priority under 35 USC §119 from Korean Patent Application No. 10-2009-0001527, filed on Jan. 8, 2009, in the Korean Intellectual Property Office, the disclosure of which is incorporated herein in its entirety by reference.

### BACKGROUND

1. Field of the General Inventive Concept

The present general inventive concept relates to an inkjet printer that applies a suction force to spitted ink or a printing medium that moves along a printing path, and a method of operating the inkjet printer.

2. Description of the Related Art

An inkjet printer prints an image by ejecting droplets of printing ink through a nozzle chip at a desired position on a paper. The inkjet printer is classified as a shuttle type and an array type according to the form of a head that ejects ink droplets. The shuttle type inkjet printer that performs printing as a head including a single nozzle chip is reciprocally moved in a width direction of a paper, and the array type inkjet printer performs printing line by line via multiple nozzle chips arranged along a width direction of a paper. Recently, an array type head, which is advantageous in terms of printing speed, has been frequently used.

Meanwhile, if a printing operation using the inkjet head is stopped for a long time, ink remaining in a droplet outlet of a nozzle chip, that is, in a nozzle, dries and solidifies, thereby obstructing the nozzle. This is referred to as clogging. Thus, droplets cannot pass through the obstructed nozzle, and a desired image cannot be properly printed. In order to solve this problem, the inkjet printer performs a spitting operation of periodically ejecting ink droplets to prevent solidification of ink when the printing operation is stopped. Spitted ink is temporarily accommodated in a platen disposed below the inkjet head and is eliminated by natural evaporation. However, in the case of array type heads which have been recently used, a large amount of ink is ejected during a spitting operation, and the spitted ink may not be sufficiently eliminated only by natural evaporation. Accordingly, a stable printing operation is required that can eliminate the ejected ink. In addition, as a thick printing medium with low flexibility has been frequently recently used, a method of allowing the printing medium to flatly pass between the inkjet head and the platen has also been considered.

### SUMMARY

The present general inventive concept provides an inkjet printer having a suction function and a method of operating the inkjet printer including a suction instrument that applies a suction force from a platen toward the suction instrument so as to closely attach a printing medium to the platen during a printing operation and to suck spitted ink in a printing standby state.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printer including an inkjet head to form an image on a printing medium, a platen disposed to face the inkjet head, a suction instrument to apply a suction force via the platen, a transporting unit to transport the printing medium, and a control unit to operate the suction instrument.

The control unit may operate the suction instrument when a rear portion of the printing medium passes between the inkjet head and the platen during a printing operation or when spitted ink is to be sucked from the inkjet head to the platen in a printing standby state.

The suction instrument may include a suction pump that is connected to the platen, a waste ink container to store the ink sucked from the platen via the suction pump, and a tube that connects the platen, the suction pump, and the waste ink container.

The tube may include a first tube connecting the platen and the suction pump and a second tube that is branched off from the first tube and is connected to the waste ink container, wherein a check valve that allows only a one-directional flow of a fluid is disposed in the first and second tubes, respectively.

The suction pump may be a Bellows pump that generates a suction force by repeatedly contracting and expanding, and a felt member into which ink soaks may be disposed on the platen.

The foregoing and/or other aspects and utilities of the present general inventive concept may also be achieved by providing a method of operating an inkjet printer, the method including preparing an inkjet head to form an image on a printing medium, a platen disposed to face the inkjet head, a suction instrument to apply a suction force via the platen, and a control unit operating the suction instrument, and applying a suction force via the suction instrument that is operated by the control unit, when a rear portion of the printing medium passes between the inkjet head and the platen during a printing operation or when spitted ink is sucked from the inkjet head to the platen in a printing standby state.

The method may further include setting a type of the printing medium before starting the printing operation and applying a suction force from the platen toward the suction instrument at the rear portion of the printing medium if the printing medium is thicker than a common printing medium.

The foregoing and/or other aspects and utilities of the present general inventive concept may also be achieved by providing an inkjet unit usable in an image forming apparatus, including a platen disposed to face an external inkjet head to form a gap therebetween and to support a printing medium in the gap, and a suction instrument disposed to apply a suction force to the platen.

The suction instrument may generate the suction force to the platen to remove an object from the platen. The suction instrument may generate the suction force via the platen to the printing medium.

The platen may include a felt member disposed on a portion of the platen, and the suction instrument may be connected to the platen to apply the suction force to the felt member such that an object is removed from the felt member.

The platen may include one or more guide ribs disposed along a feeding path of the printing medium, and one or more felt members disposed between the guide ribs, and the suction instrument comprises a tube connected to the platen to apply the suction force to the one or more felt members.

The inkjet unit may include a frame, wherein the platen and the suction instrument may be formed in the frame.

The platen may include one or more suction holes disposed in the platen to be connected to the suction instrument.

The suction holes may be disposed in a direction having an angle with a feeding path of the printing medium.

The suction holes may be disposed in a feeding direction of the printing medium.

The foregoing and/or other aspects and utilities of the present general inventive concept may also be achieved by providing an inkjet print head to eject ink, a feeding unit to feed a printing medium, an inkjet unit having a platen disposed to face an external inkjet head to form a gap therebetween and to support a printing medium in the gap, and a suction instrument disposed to apply a suction force to the platen.

The suction unit may generate the suction force to the platen to remove ink from the platen.

The suction instrument may generate the suction force to be applied to the printing medium through the platen to cause the printing medium to be biased toward the platen.

The inkjet printer may also include a detection unit disposed adjacent the transporting unit to detect a rate of flow of the printing medium and to notify the controller if the printing medium is transported at less than a predetermined speed.

The foregoing and/or other aspects and utilities of the present general inventive concept may also be achieved by providing a method of operating an inkjet printer, the method including preparing an inkjet head to form an image on a printing medium, a platen disposed to face the inkjet head, a transporting unit to transport the printing medium between the inkjet head and the platen, a suction instrument to apply a suction force via the platen, and a control unit to operate the suction instrument, detecting with a detection a unit a rate of flow of the printing medium through the transporting unit, and applying a suction force via the suction instrument that is operated by the control unit when the detection unit detects a rate of flow of the printing medium being transported at less than a predetermined speed

The detection unit may notify the control unit when the printing medium is being transported at less than a predetermined speed.

### BRIEF DESCRIPTION OF THE DRAWINGS

The above and other features and utilities of the present general inventive concept will become more apparent by describing in detail exemplary embodiments thereof with reference to the attached drawings in which:

These and/or other aspects and utilities of the present general inventive concept will become apparent and more readily appreciated from the following description of the embodiments, taken in conjunction with the accompanying drawings of which:

FIG. 1 illustrates an inkjet printer according to an embodiment of the present general inventive concept;

FIG. 2 illustrates a suction instrument of the inkjet printer of FIG. 1; and

FIG. 3 is a view illustrating an example of use of the suction instrument of FIG. 2.

### DETAILED DESCRIPTION OF THE EMBODIMENTS

The present general inventive concept will now be described more fully with reference to the accompanying drawings, wherein like reference numerals refer to the like elements throughout. Exemplary embodiments of the present general inventive concept are described below and illustrated in the accompanying figures.

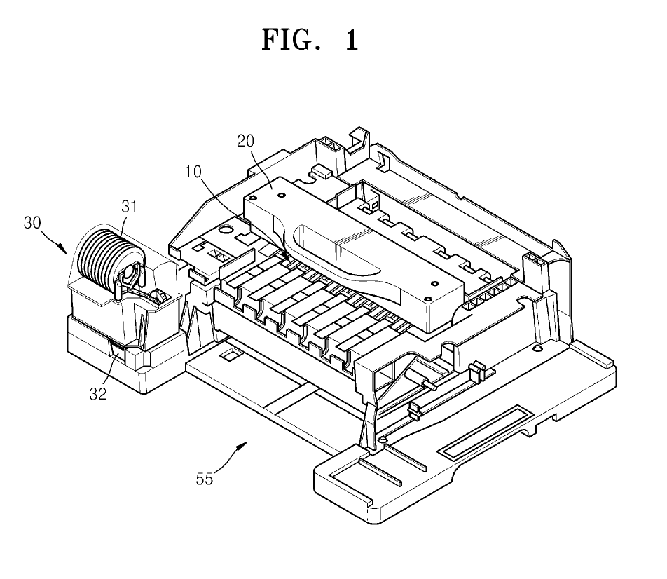

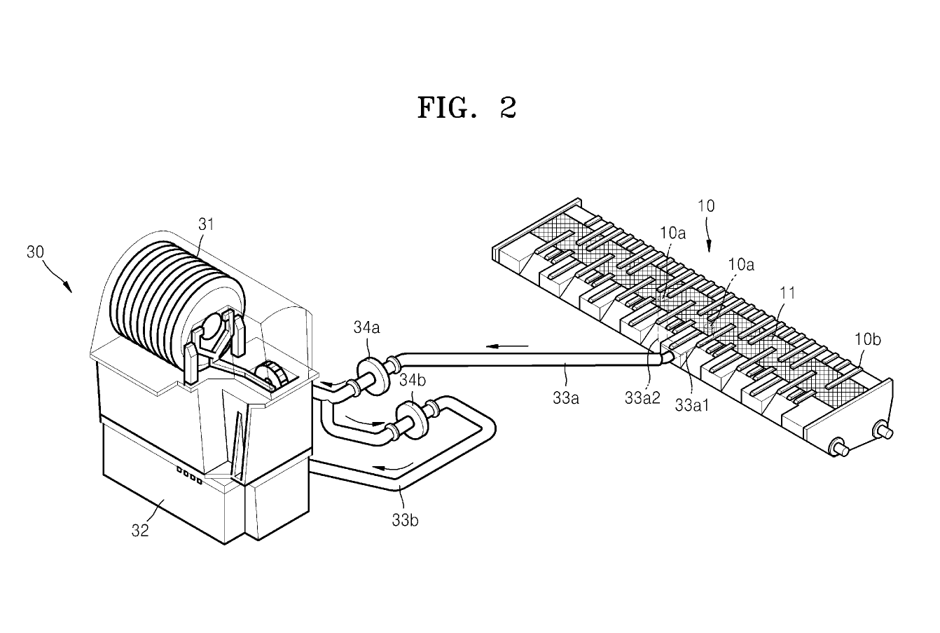

FIG. 1 illustrates an inkjet printer having a suction function according to an embodiment of the present general inventive concept, and FIG. 2 illustrates a suction instrument 30 of the inkjet printer of FIG. 1 which applies a suction force to the inkjet printer via a platen 10. The inkjet head 20, the platen 10 and the suction instrument 30 may be disposed within a frame 55 of an inkjet printer or other image forming apparatus. Alternatively, the suction instrument 30 may not be disposed within the frame 55, but may be external to the frame 55 and connected thereto by a connection pipe.

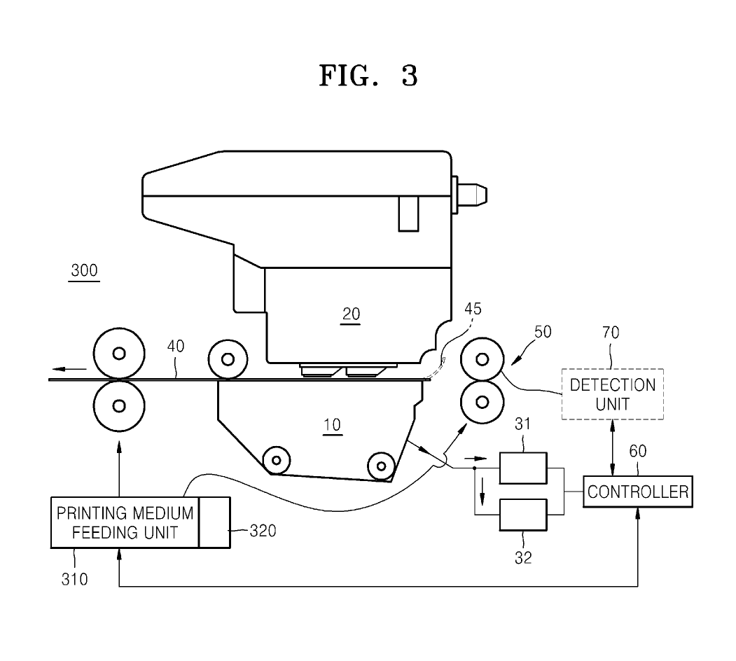

As illustrated in FIG. 1, the inkjet printer according to the current embodiment of the present general inventive concept includes an inkjet head 20 that ejects ink onto a printing medium to form an image, and a platen 10 that is disposed to face the inkjet head 20 and supports the printing medium. Thus, when a printing operation is initialized, the printing medium passes between the inkjet head 20 and the platen 10 (see FIG. 3), while the inkjet head 20 ejects ink thereon to form an image. When a maintenance operation is initialized, the inkjet head 20 may eject ink in a spitting operation, and the spat ink may remain on the platen 10 or contaminate the platen 10.

As illustrated in FIGS. 1 and 2, a suction instrument (or suction unit) 30 to apply a suction force toward the platen 10 is included in the inkjet printer according to the current embodiment of the present general inventive concept. The suction instrument 30 may include a suction pump 31 of a Bellows type that is connected to the platen 10, a waste ink container 32 storing ink that is sucked in the platen 10, and first and second tubes 33a and 33b that connect the suction pump 31, the waste ink container 32, and the platen 10. Accordingly, when the suction pump 31 starts operating, a suction force is applied near or around one or more suction holes 10a through one or more sub-tubes 33a1, 33a2 of the platen 10 that is connected to the first tube 33a, and an object sucked by the suction force goes into the suction pump 31 through the first tube 33a. The number of sub-tubes 33a1, 33a2 is not limited to two as illustrated in FIG. 2, but may be a higher number and spread out along the width of the platen 10 to provide uniform and more powerful suction to the platen. Since the suction pump 31 is a Bellows pump that repeatedly contracts and expands, the sucked object may be sucked therein through the first tube 33a during contracting and may be forced out in the opposite direction during expanding. Thus, first and second check valves 34a and 34b that allow only a one-directional flow of a fluid are used to prevent the sucked object from being pushed toward the platen 10. Accordingly, when the suction pump 31 contracts, the object enters the suction pump 31 through the first tube 33a, and when the suction pump expands, the object cannot approach the platen 10 due to the first check valve 34a but enters the waste ink container 32 through the second tube 33b. When the suction pump 31 contracts again, the object cannot be sucked out again from the waste ink container 32 due to the second check valve 34b.

The object may be ink that is temporarily accommodated in the platen 10 during a spitting operation or a printing operation. A felt member 11 is attached to at least a portion of the platen 10. During the spitting operation, ink is soaked first into the felt member 11, and when the suction instrument 30 starts operating, the ink remaining on the platen 10 is sucked through the one or more suction holes 10a, through the one or more sub-tubes 33a1, 33a2, and into the waste ink container 32 through the first and second tubes 33a and 33b as described above.

The suction hole 10a may have an end disposed at the felt member 11 so that the suction force is applied to the felt member 11 such that the ink in or around the felt member 11 is sucked through the suction hole 10a. The suction hole 10a may include a plurality of holes and be disposed on a portion of the platen 10. The platen 10 also may include a plurality of guide ribs 10b disposed along a feeding path of the printing medium, and one or more felt members 11 is disposed between the guide ribs 10b.

Meanwhile, the suction instrument 30 may be used not only to suck the spitted ink but also to help a printing medium move while being closely attached to the platen 10. This function may be useful when a thick printing medium such as a photo paper is used. Since a thick printing medium has little flexibility as illustrated in FIG. 3, a rear portion 45 of a printing medium 40 may be rolled up as indicated with a dotted line after passing through a nip formed by feed rollers 50 operating as a paper transporting unit. In this case, the rear portion of the printing medium 40 may be scratched or otherwise impeded by contacting the inkjet head 20, which decreases the printing quality. Thus, when the suction instrument 30 is operating, the suction force applied through the platen 10 may help the printing medium 40 move by closely attaching the entire printing medium to the platen 10 even if the rear portion of the printing medium 40 is normally rolled up.

As illustrated in FIG. 3, the inkjet printer may further include a control unit (controller) 60 to control the overall operation of an image forming apparatus 300 including the inkjet printer and components thereof including the suction instrument 30 and the detection unit 70. The controller also controls a printing medium feeding unit 310 and pick-up roller unit 320 to supply power, operation commands, and a printing medium to the feed rollers 50 and other components of the image forming apparatus 300. For example, the control unit 60 may control the suction instrument 30 so that a rear portion 45 of a printing medium, e.g., a photo paper which is thicker than a general printing medium, is closely attached to the platen 10 so that the suction created by the suction instrument 30 is able to help attach and propel the printing medium 40 forward. Also, the controller 60 may control the operation of the suction instrument 30 such that spitted ink may be removed as described above. Before starting a printing operation, the user may select the type of a printing medium from one of a common paper and a thick paper such as a photo paper. In other words, the user may select the type of paper by using a manipulation panel (not illustrated) included in the inkjet printer or remotely by an external control apparatus such as a computer.

The control unit 60 may operate the suction instrument 30 so that the rear portion of the paper is closely attached to the platen 10 when the selected paper is thicker than a common paper. Since common paper such as white letter paper is thinner and more flexible, a rear portion thereof is rarely rolled up, and thus there is less need to operate the suction instrument 30 when common paper is used to remedy such a problem. However, the suction instrument 30 may be used with common paper when other problems arise, such as using colored paper which may have a different texture than common white paper, or when the common paper may have pre-formed creases or wrinkles.

Also, a user may select to use the suction option when using other types of media such as a transparency, that may have a tendency to slide around while images are being formed thereon. Thus, the suction provided by the suction instrument 30 may more closely adhere the transparency to the platen 10. Also, other types of paper such as resume or other bonded paper, which may be thicker than common paper and have characteristics such as water marks that could cause slippage if not properly adhered between the platen 10 and inkjet head 20, may be selected by a user.

The inkjet printer may further include a detection unit 70 positioned at the rollers 50 or elsewhere to detect and notify the controller 60 of irregularities in the flow of a printing medium, as will be described later.

The inkjet printer may operate as follows.

During a printing operation, a printing medium may pass between the print head 20 and the platen 10 while ink is ejected thereon. In the case when the user has selected a thick or other non-common type of printing medium, the controller may control the suction instrument 30 to start operating when a rear portion of the printing medium passes between the print head 20 and the platen 10. During that time, a suction force is applied near or around the suction hole 10a through the sub-tubes 33a1, 33a2 of the platen 10 by the suction pump 31 which causes a suction force to more closely adhere the printing medium to the platen 10. Accordingly, the printing medium can more easily pass between the print head 20 and the platen 10 while being closely attached to the platen 10 due to the suction force even after the printing medium passed through a nip formed by the feed rollers 50 and the rear portion of the printing medium is rolled up.

In a case when a user has not selected a thick or other non-common type of printing medium, a detection unit 70 positioned adjacent the feed rollers or elsewhere in the image forming apparatus 300 may detect whether an end of a printing medium is rolled up, or other printing medium conditions. Often not only a thicker printing medium, but a common printing medium that is creased or wrinkled, colored paper, transparencies, etc., may cause a printing medium to be transferred through the rollers 50 to position between the inkjet head 20 and platen 10 slower than desired. Therefore, when a printing medium 40 is passed through the rollers 50, the detection unit 70 may detect whether or not the printing medium 40 is passing through the rollers 50 at a predetermined rate of speed. Predetermined speed values may be stored in a memory of the controller 60. If for any reason the printing medium is passing through the rollers and between the inkjet head 20 and platen 10 slower than the predetermined speed, the detection unit 70 may notify the controller of such a condition. The controller 60 may then activate the suction instrument 30 to apply a suction force through the platen 10. The suction force causes the printing medium 40 to be more closely adhered to the platen 10 and thus transferred at a rate of speed required by the inkjet printer.

In a printing standby state, a spitting operation to prevent solidification of ink is performed periodically, and in this case, the suction instrument 30 starts operating in order to suck up the spitted ink into a waste ink container 32. That is, when a spitting operation is performed, ink ejected from the print head 20 is first soaked into the felt member 11, and when the suction pump 31 starts operating thereafter, the soaked ink is sucked into the waste ink container 32 through the first and second tubes 33a and 33b. Accordingly, even when a large amount of ink is ejected during a spitting operation as in the case of an array type printhead, pollution in the print head's vicinity, which may be caused due to the limited ink containing capacity of the platen 10, is not generated.

Accordingly, a stable printing operation is provided using the inkjet printer according to the current embodiment of the present general inventive concept.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims and their equivalents.

What is claimed is:

1. An image forming apparatus comprising:
an inkjet head to form an image on a printing medium;
a platen disposed to face the inkjet head;
a suction instrument to apply a suction force via the platen;
a transporting unit to transport the printing medium; and
a control unit to operate the suction instrument.

2. The image forming apparatus of claim 1, wherein the control unit operates the suction instrument when a rear portion of the printing medium passes between the inkjet head and the platen during a printing operation or when spitted ink is to be sucked from the inkjet head to the platen in a printing standby state.

3. The image forming apparatus of claim 1, wherein the suction instrument comprises:
a suction pump that is connected to the platen;
a waste ink container to store the ink sucked from the platen via the suction pump; and
a tube that connects the platen, the suction pump, and the waste ink container.

4. The image forming apparatus of claim 3, wherein the tube comprises a first tube connecting the platen and the suction pump and a second tube that is branched off from the first tube and is connected to the waste ink container,
wherein a check valve that allows only a one-directional flow of a fluid is disposed in the first and second tubes, respectively.

5. The image forming apparatus of claim 3, wherein the suction pump is a Bellows pump that generates a suction force by repeatedly contracting and expanding.

6. The image forming apparatus of claim 1, wherein a felt member into which ink soaks is disposed on the platen.

7. The image forming apparatus of claim 1, further comprising:
a detection unit disposed adjacent the transporting unit to detect a rate of flow of the printing medium and to notify the controller if the printing medium is transported at less than a predetermined speed.

8. An inkjet unit usable in an image forming apparatus, comprising:
a platen disposed to face an external inkjet head to form a gap therebetween and to support a printing medium in the gap; and
a suction instrument disposed to apply a suction force to the platen.

9. The inkjet unit of claim 8, wherein the suction instrument generates the suction force to the platen to remove an object from the platen.

10. The inkjet unit of claim 8, where the suction instrument generates the suction force via the platen to the printing medium.

11. The inkjet unit of claim 8, wherein:
the platen comprises a felt member disposed on a portion of the platen; and
the suction instrument is connected to the platen to apply the suction force to the felt member such that an object is removed from the felt member.

12. The inkjet unit of claim 8, wherein:
the platen comprises one or more guide ribs disposed along a feeding path of the printing medium, and one or more felt members disposed between the guide ribs; and
the suction instrument comprises a tube connected to the platen to apply the suction force to the one or more felt members.

13. The inkjet unit of claim 8, further comprising:
a frame;
wherein the platen and the suction instrument are formed in the frame.

14. The inkjet unit of claim 8, wherein the platen comprises one or more suction hole disposed in the platen to be connected to the suction instrument.

15. The inkjet unit of claim 14, wherein the suction holes are disposed in a direction having an angle with a feeding path of the printing medium.

16. The inkjet unit of claim 14, wherein the suction holes are disposed in a feeding direction of the printing medium.

17. An image forming apparatus, comprising:
an inkjet print head to eject ink;
a feeding unit to feed a printing medium; and
an inkjet unit having a platen disposed to face an external inkjet head to form a gap therebetween and to support a printing medium in the gap and a suction instrument disposed to apply a suction force to the platen.

18. The image forming apparatus of claim 17, wherein the suction unit generates the suction force to the platen to remove ink from the platen.

19. The image forming apparatus of claim 17, wherein the suction instrument generates the suction force to be applied to the printing medium through the platen to cause the printing medium to be biased toward the platen.
